(19) United States
(12) Patent Application Publication
(10) Pub. No.: US 2008/0159305 A1
(43) Pub. Date: Jul. 3, 2008

(54) Virtual private communication devices and techniques

(76) Inventors: John Mark Morris, San Diego, CA (US); Linda Morris, Poway, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/646,656

(22) Filed: Dec. 28, 2006

(51) Int. Cl. H04L 12/56

(52) U.S. Cl. 370/401

(57) ABSTRACT

Virtual private communication devices and techniques are presented. A communication device includes a virtual private service that can be activated on the communication device with proper credentials associated with a private account. Once activated, the communication device is configured with settings, profiles, and call logs associated with the private account. Moreover, transaction history for the communication device is tied to the private account when the communication device operates under the private account.

### FIELD

The invention relates generally to security and more particularly to virtual private communication devices and techniques.

### BACKGROUND

Mobile phones are pervasive in the world. Nearly every household owns one or more cell phones. In fact, it has reached a point where nearly every adult, and sometimes even every teenager, in the United States owns his/her own cell phone.

The phones today include a variety of processing and storage capabilities. Individuals can play games on the phones, take pictures, send email, surf the World-Wide Web (WWW), take video, etc. In fact, composite devices, such as personal digital assistants, and laptops can now also double as a mobile phone. Some phones can communicate over cellular or satellite transmissions and at the same time, where available, communicate over the Internet. Thus, the lines between what use to be considered a phone and what use to be considered a computer are becoming blurred almost to the point of non existence.

However, phones today include very little security or privacy for the individuals that operate them. Thus, if an individual's phone falls into the wrong hands of another, that person having the phone can rapidly acquire a variety of information, such as call logs, contacts, etc.

Moreover, some individuals carry phones for their jobs and information on these phones may be sensitive to an enterprise and not just to the individuals that use and regularly carry the phones. The problem is not limited to commercial enterprises either, since government employees often carry phones in the course of their employment as well.

Thus, it can be seen that improved mechanisms for privacy when using phones are needed.

### SUMMARY

In various embodiments, virtual private communication devices and techniques are presented. According to an embodiment, a virtual private communication device is provided. The virtual private communication device includes a transceiver, a processor, and memory. The memory includes a virtual private service that is processed by the processor. Furthermore, the virtual private service is to manage a private account and restrict access to the private account. The private account includes its own settings, profiles, and call logs associated with initiating calls and receiving calls via the transceiver.

### BRIEF DESCRIPTION OF THE DRAWINGS

FIG. 1 is a diagram of a virtual private communication device, according to an example embodiment.

FIG. 2 is a diagram of a method for operating a virtual private device, according to an example embodiment.

FIG. 3 is a diagram of a method for a server service that interacts with a virtual private communication device, according to an example embodiment.

### DETAILED DESCRIPTION

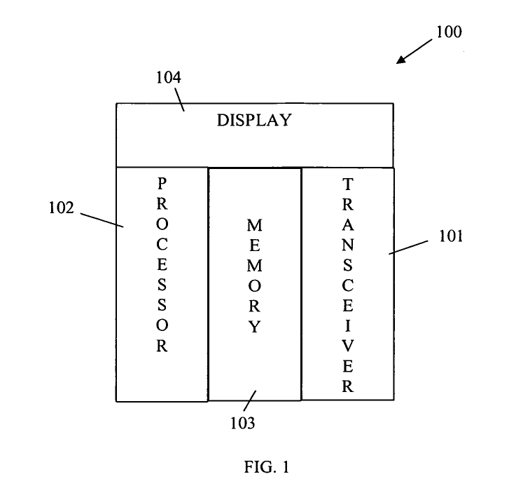

FIG. 1 is a diagram of a virtual private communication device 100, according to an example embodiment. The virtual private communication device 100 is implemented in a communication device, such as a phone, a personal digital assistant, a computer, etc. The virtual private communication device 100 also includes software that processes on the device, which permits the communication device to assume a designation and become a virtual private communication device 100. Moreover, the virtual private communication device 100 communicates over a network. The network may be wired, wireless, or a combination of wired and wireless.

The virtual private communication device 100 may communicate using protocols associated with cellular, satellite, cable, and/or the Internet. In some case, the virtual communication device 100 can operate over existing Plain Old Telephone (POT) lines, over fiber optics, and/or wireless transmissions.

The virtual private communication device 100 includes a transceiver 101, a processor 102, and memory 103. The virtual private communication device 100 may also include a display 104. Each of these will now be discussed in turn.

The transceiver 101 permits voice and/or data transmissions to be sent from the virtual private communication device 100 over a network to a recipient. The transceiver 101 also permits voice and/or data to be received from a recipient over the network.

The processor 102 permits data and voice processing on the virtual private communication device 100. The processor 102 interacts with the memory 103 to perform a variety of functions on the virtual private communication device 100.

The memory 103 also includes a virtual private service. The virtual private service is capable of being and is, under the proper circumstances, initiated and processed by the processor 102.

The virtual private service is to authenticate credentials received for a private account. The credentials may include an identifier and a password. Alternatively, the credentials may be a biometric piece of information, such as a voice print, finger print, retinal scan, etc. When the proper credentials are received, the virtual private service configures the virtual private communication device 100 to operate under and in a session as the private account.

During configuration of the private account and its session, the virtual private service retrieves settings, profiles, and/or call logs associated with the private account. Settings may include contacts, emails, speed dial numbers, distinctive ring tones, photos, spreadsheets, voice mail, images, presentations, text messages, etc. Profiles may include motifs, color themes, display configurations, default key assignments, etc. The call log may include such things as received calls, missed calls, dialed calls, etc.

The virtual private service configures the virtual private communication device 100 with the settings, profiles, and/or call logs associated with the private account. According to an embodiment, the settings, profiles, and/or call logs are not maintained on the virtual private communication device 100 in non volatile memory or storage; rather it is natively stored and managed over a network on a remote and secure server. Thus, when the private account is established, the virtual private service contacts the server over the network authenticates itself and perhaps the private account and acquires the settings, profiles, and/or call logs, which are then downloaded and configured in the virtual private communication device 100.

The virtual private service manages the private account and restricts access to the private account. In other words, the private account and its settings, profiles, and/or call logs are only accessible when the proper authentication credentials are supplied. In fact, the virtual private service may itself remain hidden within the memory 103 of the virtual private communication device 100 when the virtual private communication device 100 operates under a conspicuous account.

A conspicuous account is a normal account associated with the communication device to which the virtual private communication device 100 is associated. For example, a normal cell phone has but one account and that is of the user that operates it. With the virtual private communication device 100 a user can assume a variety of private accounts, all of which remain hidden, secret, and private on the cell phone.

It is also understood that although a single private account is being discussed that the virtual private communication device 100 is not so limited. In fact, multiple and even hierarchical or nested private accounts may be established with the virtual private communication device. Each private account may remain anonymous on the virtual private communication device from the other remaining private accounts.

The private account(s) and the conspicuous account each share the same phone number on the virtual private communication device 100. However, activity and settings associated with each maintained private account is just retrievable, usable, and viewable when proper authentication credentials are supplied to the virtual private service.

According to an embodiment, the virtual private communication device 100 also maintains a transaction history for the private account in secret. Thus, when calls are received or made via the transceiver 101 while the virtual private communication device 100 is operating under the private account, the calls are not traceable or viewable when the virtual private communication device 100 is subsequently operating under the conspicuous account. Calls are received and made via the transceiver 101.

The virtual private communication device 100 may also include a viewable display 104. The virtual private service may be initiated when a login prompt is presented on the display to an operator. The operator supplies credentials to assume the private account or to direct the virtual private service to designate the communication device as the virtual private communication device 100 and direct it to operate under the private account. The very existence of the virtual private service may be undiscoverable to an operator assuming the conspicuous or default account. It is not until a proper login prompt is initiated and proper credentials supplied that the virtual private service initiates and designates the communication device as a virtual private communication device 100 operating as the private account.

In some cases, the virtual private communication device 100 may also block phone calls received when it is in an active state. That is, for some virtual private accounts incoming phone numbers, text messages, or emails have to be registered with those virtual private accounts or they are blocked from being received or detected from the virtual private communication device 100 when it is in a particular active virtual private account state. So, in some embodiments phone numbers or email address have to be registered for a particular virtual private account and if they are not they are blocked from being detected at all. The particular account to which these incoming calls or text messages are received will still note the transaction details but it would be a missed call, email, or text message and would just be discoverable when the virtual private communication device 100 assumes the proper virtual private account to which this information is registered.

It is now understood how a traditional communication device, such as a phone, PDA, or even laptop under some circumstances, may be transformed into a virtual private communication device 100 where settings, profiles, call logs, and transaction history remain hidden and secret to other private accounts on the communication device and to a conspicuous account associated with the communication device. This provides privacy and secrecy to operators, which is not available with traditional communication devices.

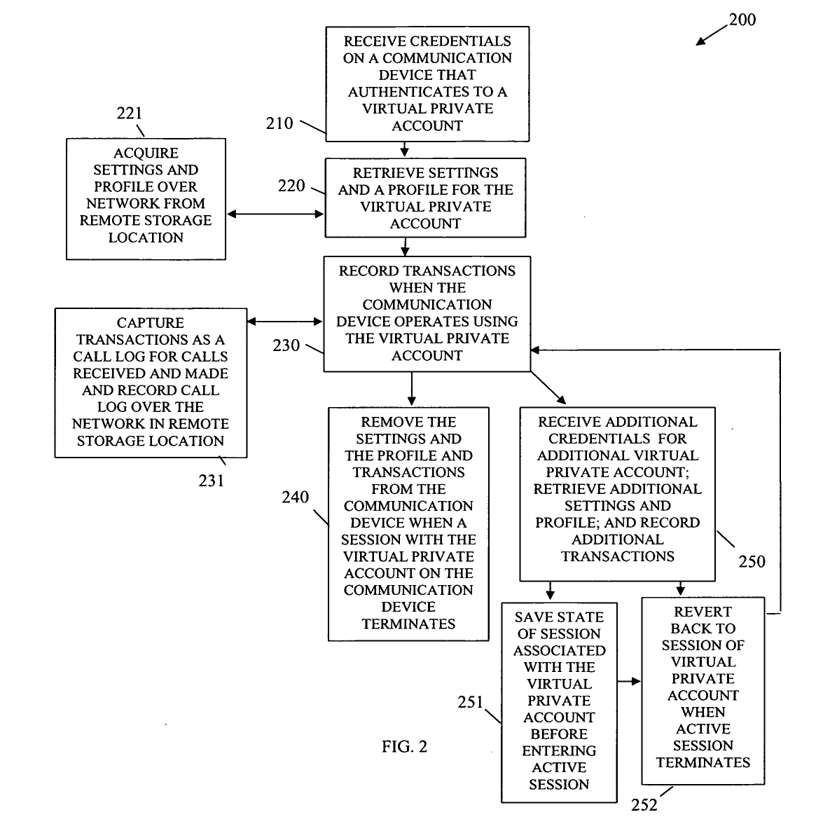

FIG. 2 is a diagram of a method 200 for operating a virtual private device, according to an example embodiment. The method 200 (hereinafter “private communication service”) is implemented in a machine-accessible and readable medium as instructions that when executed by a machine performs the processing reflected in FIG. 2. The machine is a communication device, such as a phone, a personal digital assistant (PDA), a computer, etc. The private communication service is also adapted to communicate over a network. The network may be wired, wireless, or a combination of wired and wireless. The private communication service represents novel processing and features that may be implemented in the virtual private communication device 100 discussed above with reference to the FIG. 1.

At 210, the private communication service receives credentials on a communication device. The credentials authenticate to a virtual private account. According to an embodiment, the private communication service is the virtual private service discussed in detail above with reference to the virtual private communication device 100 of the FIG. 1.

At 220, the private communication service retrieves settings and a profile for the virtual private account. In some situations, at 221, these settings and profile may be acquired over a network from a remote and secure storage location. In this way, the private communication service may mask and prevent any detection of the virtual private account on the communication device. In other words, the settings and profile only temporarily occupy volatile memory of the communication device while the communication device operates as a virtual private communication device 100 under the virtual private account.

At 230, the private communication service records transactions when the communication device operates using the virtual private account. So, when calls are received or missed while the communication device is assuming the virtual private account, metadata associated with the calls are recorded as transaction information and associated with just the virtual private account. Likewise, when calls are made these are also captured as transaction details associated with just the virtual private account. It is noted that transaction details may also include text messages, voice mail, video, spreadsheets, documents, pages, pictures, images, electronic mail, etc.

In an embodiment, at 231, the private communication service may capture the transactions as a call log for calls received and calls made. The call log may be recorded over the network at the remote and secure storage location; in a similar manner to how the settings and profile were initially retrieve and used to configure the communication device as a virtual private communication device under the virtual private account.

At 240, the private communication service may elect to permanently remove the settings, profile, and transactions completely from the communication device when a session with the virtual private account on the communication device terminates. This was discussed above with reference to the processing of 221. This may prevent any trace of activity associated with the virtual private account from remaining and being discoverable on the communication device.

In another case, at 250, the private communication service may receive additional credentials for an additional virtual private account. Additional settings and profile may then be retrieved and additional transactions recorded for a new active session during which the communication device assumes the new and additional virtual private account. Basically, the virtual private accounts may be nested within the communication device, such that a virtual private account may include its own virtual private accounts. Each unique virtual private account is hidden and unknown and undiscoverable by the other virtual private accounts.

It may be, at 251, that before the communication device moves from a session with the original virtual private account to a nested and new active session with a new and additional virtual private account that a state associated with the session of the original virtual private account is saved before entering a new active state with the new virtual private account. Accordingly, at 252, when the active session with the new and nested virtual private account terminates, the communication device can revert back to a same state that the communication device was in with the original virtual private account.

So, states having unique settings, call logs, profiles, etc. may be maintained as the communication device moves from one virtual private account to another. In some cases, re-authentication may be required before a state of a previous virtual account is restored. This adds privacy in case the communication device is stolen when within a nested virtual private account.

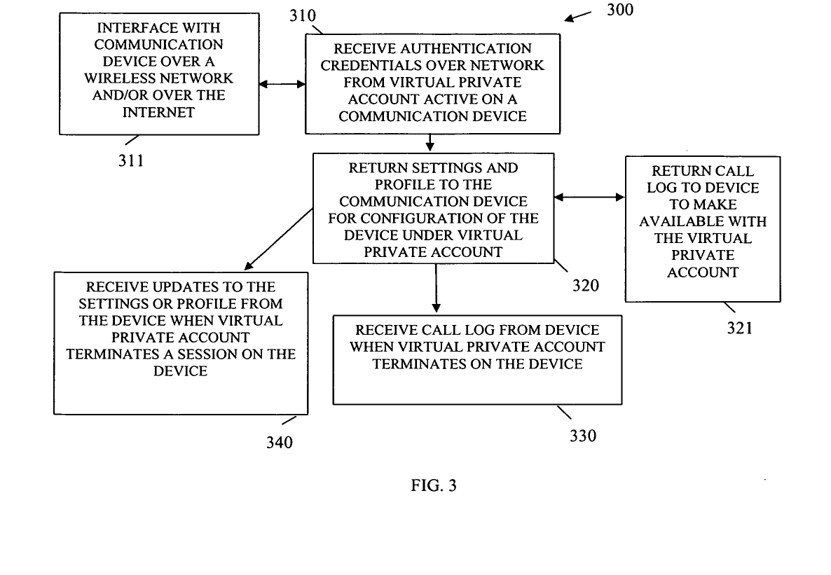

FIG. 3 is a diagram of a method 300 for a server service that interacts with a virtual private communication device. The method 300 (hereinafter “virtual communication server service”) is implemented in a machine-accessible and readable medium on a machine. The machine is a communication device, such as a phone, a personal digital assistant, a computer, etc. The virtual communication server service interacts and interfaces with the private communication service represented by the method 200 of the FIG. 2.

The virtual communication server service interacts with the system 100 and the method 200 of the FIGS. 1 and 2, respectively, to supply services in managing virtual private communication devices and virtual private accounts on those devices.

Accordingly, at 310, the virtual communication server service receives authentication credentials over a network from a virtual private account that is active on a communication device. The device may also separately supply credentials and authenticate before supplying the credentials of the virtual private account. If authentication fails then no services are supplied from the virtual communication server service to the communication device. If authentication is successful then the processing discussed herein and below may occur.

At 311, the virtual communication server service and the communication device may interface with one another in a variety of manners. For example, communication may be wired, wireless, or wired and wireless. Additionally, communication may occur over cable lines, phone lines, etc. Still further, in some situations, the communication may occur over the Internet or via the WWW.

At 320, the virtual communication server service returns settings and a profile to the communication device. The communication device uses the settings and profile to configure the communication device as a virtual private communication device operating under the virtual private account.

In some cases, at 321, the virtual communication server service may also return a call log to the communication device. The communication device then makes the call log available to the virtual private account operator for use on the communication device. The call log may include metadata associated with previously missed calls, received calls or calls made during prior sessions associated with the virtual private account.

At 330, the virtual communication server service also receives a call log from the communication device when the virtual private account terminates or ends on the communication device.

According to an embodiment, at 340, the virtual communication server service may also receive updates to the settings or profile from the communication device when the virtual private account terminates or ends a session on the communication device.

The virtual communication server service manages metadata associated with configuring a communication device to a desired state having desired information for a given virtual private account. Once the communication device is configured with the proper state and information, it becomes a virtual private communication device 100, discussed above with reference to the FIG. 1. The processing associated with the virtual private communication device 100 was discussed in detail with reference to the method 200 of the FIG. 2.

One now appreciates how traditional communication devices may be made more secure and private by assuming virtual private accounts that transform a traditional communication device into a virtual private communication device 100.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A virtual private communication device, comprising:
a transceiver;
a processor; and
memory, wherein the memory includes a virtual private service that is to be processed by the processor, and wherein the virtual private service is to manage a private account and restrict access to the private account, the private account includes its own settings, profiles, and call logs associated with initiating calls and receiving calls via the transceiver.

2. The virtual private communication device of claim 1 further comprising, a display, wherein a login prompt is presented on the display and when proper credentials are supplied via input keys, the virtual private service permits access to the private account.

3. The virtual private communication device of claim 1, wherein the virtual private service is to further maintain transaction history for the private account in secrete.

4. The virtual private communication device of claim 1, wherein the virtual private service is to maintain the settings, profiles, and call logs external to the virtual private communication device over a network on a remote server.

5. The virtual private communication device of claim 1, wherein the virtual private service is to be hidden within memory when the virtual private communication device operates under a conspicuous account.

6. The virtual private communication device of claim 5, wherein the private account and conspicuous account share a same phone number with one another on the virtual communication device.

7. The virtual private communication device of claim 5, wherein calls that are to be received or made via the transceiver, when the virtual communication device is operating under the private account, are not traceable or viewable when the conspicuous account is subsequently activated for use.

8. A method, comprising:
receiving credentials on a communication device that authenticates to a virtual private account;
retrieving settings and a profile for the virtual private account; and
recording transactions when the communication device operates using the virtual private account.

9. The method of claim 8, wherein retrieving further includes acquiring the settings and the profile over a network from a remote storage location that is external to the communication device.

10. The method of claim 9, wherein recording further includes capturing transactions as a call log for calls received and calls made, and recording the call log over the network at the remote storage location.

11. The method of claim 8 further comprising, removing the settings and the profile and the transactions from the communication device when a session with the virtual private account on the communication device terminates.

12. The method of claim 8 further comprising:
receiving additional credentials on the communication device for an additional virtual private account while a session with the virtual private account is active on the communication device;
retrieving additional settings and an additional profile for the additional virtual private account; and
recording additional transactions when the communication device operates under the additional virtual private account.

13. The method of claim 12 further comprising, reverting back to the session associated with the virtual private account when an active session with the additional virtual private account terminates.

14. The method of claim 12 further comprising, saving a state of the session with the virtual private account before entering an active session on the communication device with the additional private account.

15. A method, comprising:
receiving authentication credentials over a network from a virtual private account that is active on a communication device; and
returning settings and a profile to the communication device for the communication device to use to configure an environment on the communication device for the virtual private account.

16. The method of claim 15 further comprising, returning a call log to the communication device to make available to the virtual private account, wherein the call log is associated with a prior session the virtual private account had on the communication device.

17. The method of claim 15 further comprising, receiving a call log from the communication device when the virtual private account terminates a session on the communication device.

18. The method of claim 15 further comprising, receiving updates to the settings or the profile from the communication device when the virtual private account terminates a session on the communication device.

19. The method of claim 15 further comprising, interfacing with the communication device over a wireless network.

20. The method of claim 15 further comprising, interfacing with the communication device over the Internet.
